(19) United States
(12) Patent Application Publication
(10) Pub. No.: US 2014/0132015 A1
(43) Pub. Date: May 15, 2014

(54) Shovel Attachment

(71) Applicant: Breanna L. Stachowski, Elma, NY (US)

(72) Inventor: Breanna L. Stachowski, Elma, NY (US)

(21) Appl. No.: 14/079,811

(22) Filed: Nov. 14, 2013

Related U.S. Application Data
(60) Provisional application No. 61/726,732, filed on Nov. 15, 2012.

(51) Int. Cl. A01B 1/02; E01H 5/06; E01H 5/02

(52) U.S. Cl. CPC A01B 1/026; E01H 5/02; E01H 5/061
USPC 294/51; 294/58

(57) ABSTRACT

An attachment to a conventional snow shovel functions as an auxiliary handle and as a connector to a second snow shovel. When oriented substantially perpendicular to the shovel blade, the attachment functions as an auxiliary handle. The attachment connects to the shovel near the intersection of 1) the blade and neck and 2) the neck and handle. In this embodiment, the auxiliary handle functions as a cradle in which to rotate the shovel to dump snow more easily. The attachment may also be used to combine two shovels to form a plow. The attachment connects to a first shovel at the same two points as in the first configuration. In the same way, another attachment connects to the neck of a second shovel. The two attachments connect to each other at a third attachment point along the body of the attachments, creating a plow formed by the adjacent shovel blades.

### CROSS REFERENCE TO RELATED APPLICATIONS

This application claims the benefit of U.S. Provisional Application No. 61/726,732 Snow Shovel Attachment, filed Nov. 15, 2012.

### BACKGROUND

Manually removing snow from sidewalks and drive ways is time-consuming and exhausting. Shoveling can be a dangerous activity, in part because of the strenuous, physical motions required to bend, scoop the snow, lift the load, and then dump the snow. The repetitive motions and strenuous nature of shoveling may result in bodily injuries, especially to the back; overexertion; and even heart failure.

A standard shovel requires significant bending to scoop the snow, causing the user to practice unsafe positions across a large range of back movements, including a twisting motion in the lower back of a shovel user. Despite the progress that ergonomic shovels have made in reducing some strain to the back, dumping the snow still required the user to employ awkward body positions, including twisting the torso.

In addition, standard snow shovels are poorly suited to clear larger areas, such as large driveways or parking areas. A wide shovel blade can be used to efficiently plow surface to be cleared, but a narrower blade may be preferred for lifting and dumping of snow. Too wide a shovel blade may make it difficult for users to use the shovel based upon the strength required to lift and dump the snow. And, a wide blade shovel or snow plow is not well suited for clearing tighter areas, including steps and narrow sidewalks. Maintaining a separate snow plow and snow shovel requires extra space for storing these large tools and of course, additional expense in purchasing both items.

### BRIEF SUMMARY

The devices and methods described herein facilitate shoveling and plowing of snow. In certain embodiments, an attachment connects to a conventional snow shovel having a handle, an elongated neck, and a blade at the lower end. The attachment functions as an auxiliary handle that allows the user to exert less force and use fewer bending and twisting motions than are normally required to dump snow from a standard snow shovel. The attachment also functions as a connector to a second snow shovel assembly to form a snow plow. In embodiments, the attachment connects to the shovel near the intersection of 1) the blade and neck and 2) the neck and handle.

When oriented substantially perpendicular to the shovel blade, the attachment can function as an auxiliary handle. In embodiments, the upper and lower connectors, such as a collar, may be tightened around the neck of the shovel to create a desired amount of friction between the connector and the neck. This flexibility allows the user to determine the amount of force necessary to rotate the neck smoothly within the connectors. In this embodiment, the attachment functions as a higher handle and cradle in which to rotate the snow shovel, enabling the user to lift and dump snow with less energy and movement than are normally required.

When oriented at an angle other than perpendicular to the blade, embodiments of the attachment can also function as a connector between two shovels. In certain embodiments, the attachment connects to a first shovel as described above. In the same way, a second, separate attachment connects to the neck of a second shovel. The two attachments can be connected together to join the two shovels into a plow assembly. In this embodiment, the two connected, adjacent shovels form a snow plow, enabling the user to push the plow assembly with two handles a comfortable distance apart.

An embodiment includes an attachment for a shovel, the attachment comprising a body having a first end and a second end, wherein the body is configured to provide a user with handhold offset from a neck of the shovel when the attachment is mounted on the shovel. A lower connector is disposed at the first end of the body, wherein the lower connector is configured to attach to a neck of the shovel proximate to a blade of the shovel; and an upper connector disposed at the second end of the body, wherein the upper connector is configured to attach to the neck of the shovel proximate to a handle of the shovel and distal from the blade. The shovel is rotatable relative to the attachment when the upper connector and the lower connector are attached to the handle of the shovel.

### BRIEF DESCRIPTION OF THE DRAWINGS

The systems, devices and methods may be better understood by referring to the following description in conjunction with the accompanying drawings, in which like numerals indicate like structural elements and features in various figures. The components in the figures are not necessarily to scale and simply illustrate the principles of the systems, devices, and methods. The accompanying drawings illustrate only possible embodiments of the systems, devices, and methods and are therefore not to be considered limiting in scope.

FIG. 1A is a front view of an embodiment of a shovel attachment connected to a single shovel.

FIG. 1B is a side view of an embodiment of a shovel attachment connected to a single shovel.

FIG. 2 depicts a side view of an embodiment of the shovel attachment.

FIG. 3A is an exploded perspective view of an embodiment of a connector for the shovel attachment.

FIG. 3B is an exploded side view of an embodiment of the attachment to be mounted to a single shovel.

FIG. 3C is a side view of an embodiment of the attachment mounted to a single shovel.

FIG. 3D is a perspective view of an embodiment of a connector for a shovel attachment.

FIG. 4A is a perspective view of an embodiment of a combination element in conjunction with an embodiment of an attachment.

FIG. 4B is a perspective view of an embodiment of the combination element used to join embodiments of attachments.

FIG. 5 is a front view of an embodiment of a plow assembly formed using a pair of attachments and shovels.

FIG. 6 is a front view of an embodiment of a plow assembly formed using a pair of attachments and shovels as utilized by a user.

FIG. 7 depicts embodiments of attachments mounted to shovels and stacked for storage or shipping.

FIG. 8A depicts a user utilizing a shovel.

FIG. 8B depicts a user utilizing an embodiment of the attachment in conjunction with a standard shovel.

FIG. 8C depicts a user utilizing an ergonomic shovel.

FIG. 8D depicts an embodiment of a user dumping the contents of the shovel utilizing an embodiment of the attachment.

FIG. 9 is a perspective view of an embodiment of an attachment including a user grip.

FIG. 10 is an exploded view of an embodiment of an attachment including a user grip.

FIG. 11A is a side view of an embodiment of an attachment mounted on a shovel.

FIG. 11B is a side view of another embodiment of an attachment mounted on a shovel.

FIG. 11C is a side view of another embodiment of an attachment with grip mounted on a shovel.

FIG. 11D is a side view of an embodiment of an attachment mounted on a shovel.

### DETAILED DESCRIPTION

Aspects of the system and methods are described below with reference to illustrative embodiments. The references to illustrative embodiments below are not made to limit the scope of the invention in any way. Instead, illustrative embodiments are used to aid in the description of various aspects of the system and method. The description, made by way of example and reference to illustrations, is not meant to be limiting with regards to any aspect of the invention.

Devices and methods described in this application are especially well adapted for use in clearing and removing snow and will be described in that context. It will become apparent, however, that this is illustrative of only one utility of the described apparatuses and methods.

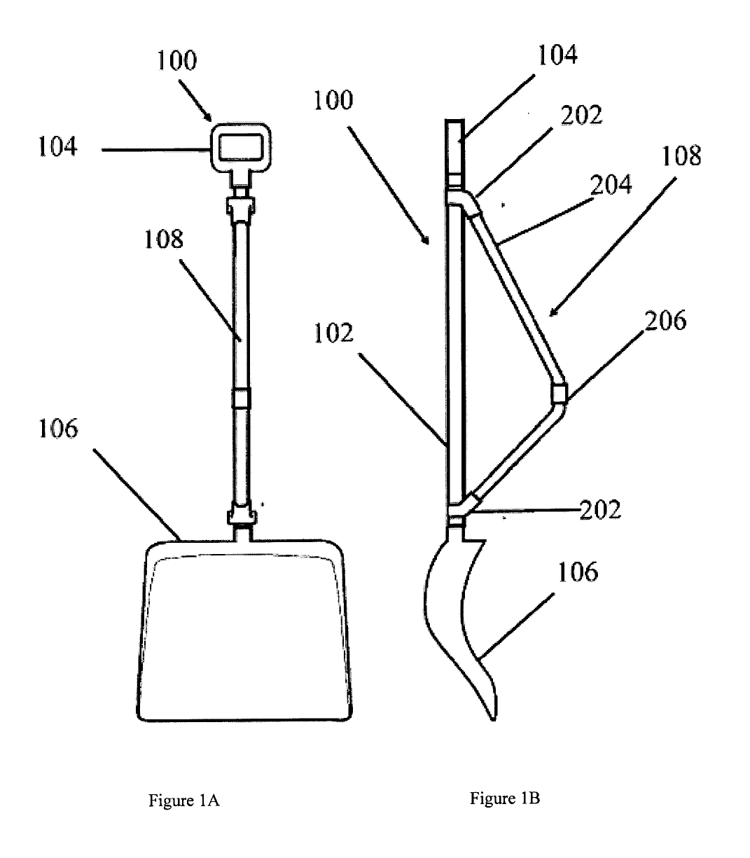

Referring now to FIGS. 1A and 1B, the standard snow shovel 100 consists of a wide blade 106 for scooping or shoveling snow, a long straight shaft or neck 102, and a grip or handle 104 at the far end of the neck 102 from the shovel blade 106. Typically, users grasp the shaft or neck 102 of the shovel 100 with one hand and the handle 104 with the other hand. To move snow, the user bends over, scoops up a blade 106 full of snow, turns, and dumps the snow out of the area to be cleared. The motion requires bending of the shoveler's back and twisting. The repetitive bending motion or twisting motion can frequently lead to back strain and soreness or injury.

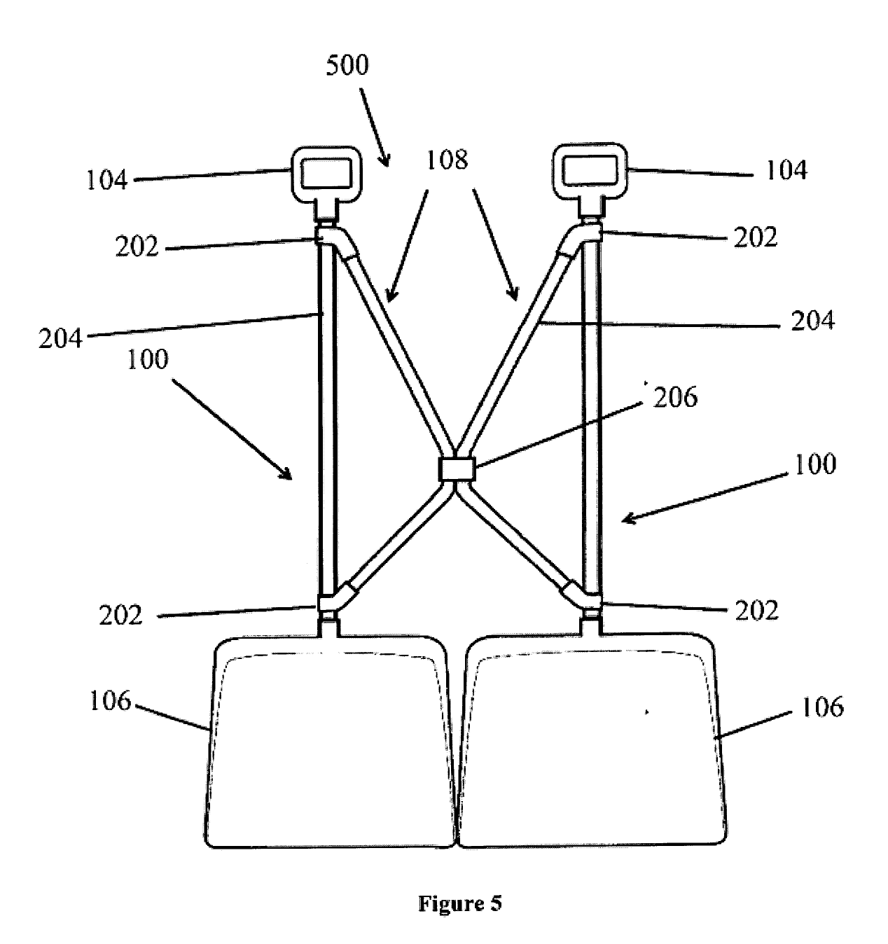

The devices and methods described herein can be used to reduce the strain on the user's back by decreasing the bending and twisting motions when using the snow shovel 100. In embodiments, an attachment 108 can be connected to a standard shovel 100. The use of the attachment 108 changes the position at which a user grasps the shovel 100, raising that grasping position off of the neck 102 to reduce the bending motion when a user utilizes the shovel 100. In other embodiments, the attachment 108 allows the user to dump snow off the shovel blade 106 merely by rotating the handle 104, reducing the torsion or twisting of the back of the user when shoveling. In further embodiments, a pair of attachments 108 can be connected to two separate shovels 100 and each other to combine to form a single snow plow 500, shown in FIG. 5 and discussed in detail below.

FIGS. 1A and 1B illustrate an embodiment of an attachment 108 that facilitates shoveling of snow connected to a single standard shovel 100. As shown, the standard snow shovel 100 is comprised of a snow shovel blade 106 attached to a snow shovel neck 102 or shaft and a snow shovel handle 104 attached at the far end of the neck 102 from the blade 106. An embodiment of the attachment 108 is comprised of a non-linear body 204 that extends a distance away from the neck 102 of the shovel 100 when the attachment 108 is connected to the shovel 100. The attachment 108 can include a lower connector 202 at one end of the body 204 that can be used to connect the attachment 108 to the shovel 100 at or near the blade 106 of the shovel 100 and an upper connector 202 at the other end of the body 204 that can be used to connect the attachment 108 to the shovel 100 at or near the handle 104 of the shovel 100.

In an embodiment, the connectors 202 attach to the neck 102 of the standard snow shovel 100 to secure the attachment 108 to the shovel 100. The attachment 108 provides an additional location that the user can grasp when shoveling. When the attachment 108 is oriented so that it extends from the neck 102 of the shovel 100 in a direction roughly perpendicular to the face of the snow shovel blade 106, as shown in FIG. 1B, the attachment 108 allows the user to grip the attachment 108 at a point higher from the ground than the user would grasp the neck 102 of the standard snow shovel 100 when shoveling. As a result, the user is not required to bend as far to grasp the body 204 of the attachment 108 as they would to grasp the snow shovel neck 102. Consequently, the user would be able to push the shovel 100 with the attachment 108 connected to it without bending down as much as he would have to if he were using a standard snow shovel without the attachment 108.

In other embodiments, the attachment 108 allows the user to ergonomically dump the snow from the blade 106 of the standard snow shovel 100. In an embodiment, the upper connector 202 and lower connector 202 each act as a collar around the shaft or neck 102 of the shovel 100, where the neck 102 rotates smoothly within these collars. The user can grasp the handle 104 of the standard snow shovel 100 with one hand and the body 204 of the attachment 108 with the other hand, lift the blade 106 of the standard snow shovel 100 off the surface on which it is being used, and rotate the standard snow shovel 100 by rotating the handle 104 without necessarily rotating the attachment 108. The standard snow shovel 100 would then dump out any contents in the blade 106. Rotating the shovel 100 can be accomplished by a simple twist of the wrist, rather than a torsion of the user's back.

Compared to the operation of a standard snow shovel 100, the attachment 108 can decrease the pain and discomfort experienced by the user, while reducing the work needed to clear snow. With a standard snow shovel 100 alone, the user normally turns his entire torso to one side or the other to dump the snow or exert a great deal of force to throw the snow over his shoulder. With an attachment 108 connected to the shovel 100, the user may be able to stand upright or minimize bending his torso while shoveling. The user can simply apply force to rotate the handle 104, instead of twisting their torso awkwardly to remove the snow from the blade of the snow shovel 106.

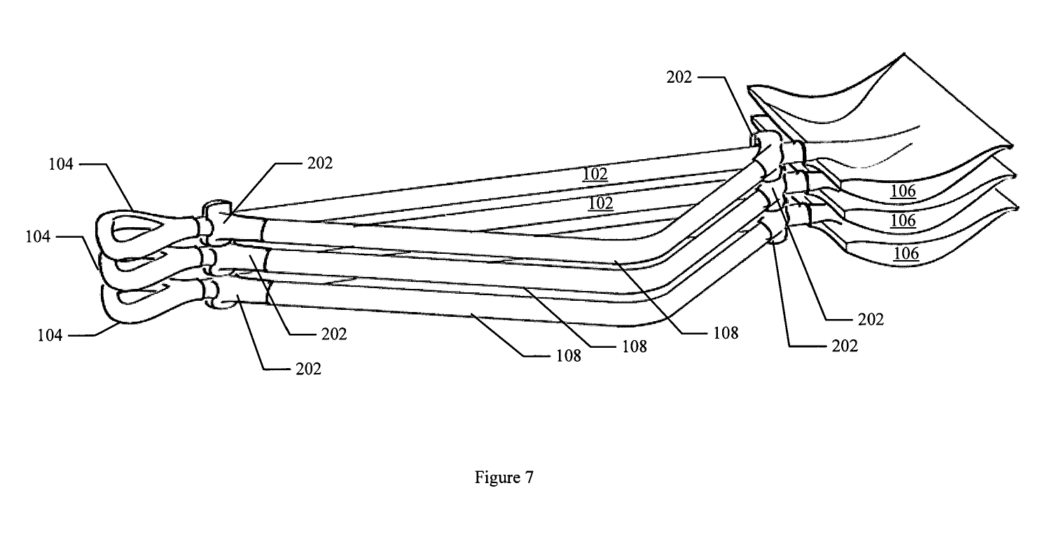

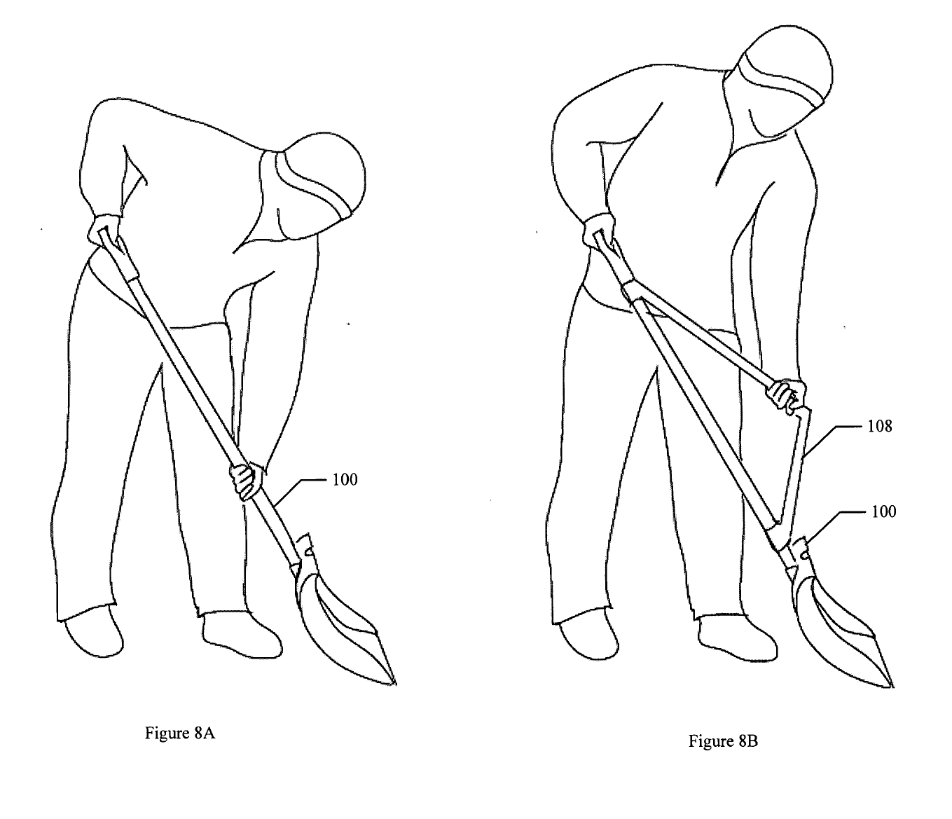

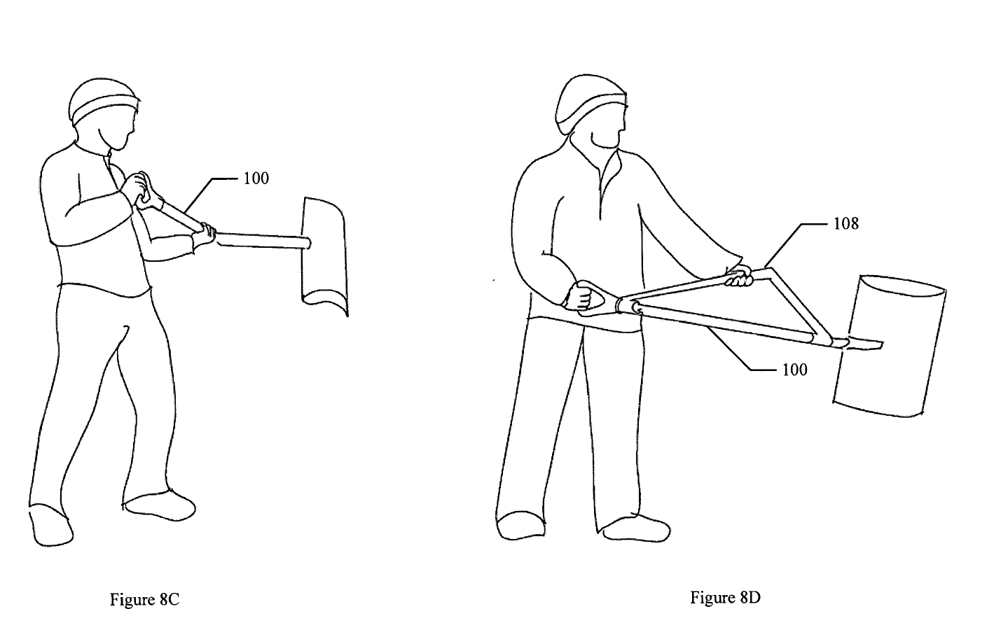

FIGS. 8A-8D illustrate use of an embodiment of the attachment 108 with a shovel 100. Turning first to FIGS. 8A and 8B, FIG. 8A shows a user with a standard shovel 100 gripping the neck 102 of the shovel in one hand and the handle 104 of the shovel 100 in the other. In comparison, the user shown in FIG. 8B utilizes a shovel 100 with an embodiment of the attachment 108, gripping the attachment 108 with one hand and the handle 104 of the shovel 100 in the other. As shown, by gripping the attachment 108, the user is able to utilize the shovel 100 with minimal bending. Here, the curvature or angle formed by the user's back in FIG. 8B is less acute than that of the user of the shovel shown in FIG. 8A. In addition, when the user grasps the shovel 100 and attachment 108, the shape of the illustrated attachment 108 creates a natural distance between the user's hands that gives the user leverage when shoveling.

Turning now to FIGS. 8C and 8D, here, a user scoops snow into the blade 106. The user may then pick up the snow, and twist to throw the snow and clear the shovel 100, as shown in FIG. 8C. This twisting motion can be very stressful on the back of the user leading to injuries. In contrast, as shown in FIG. 8D, the user utilizing the shovel 100 with the mounted attachment 108, can rotate the shovel 100 with respect to the attachment 108, and release the snow with minimal twisting or straining of the user's back.

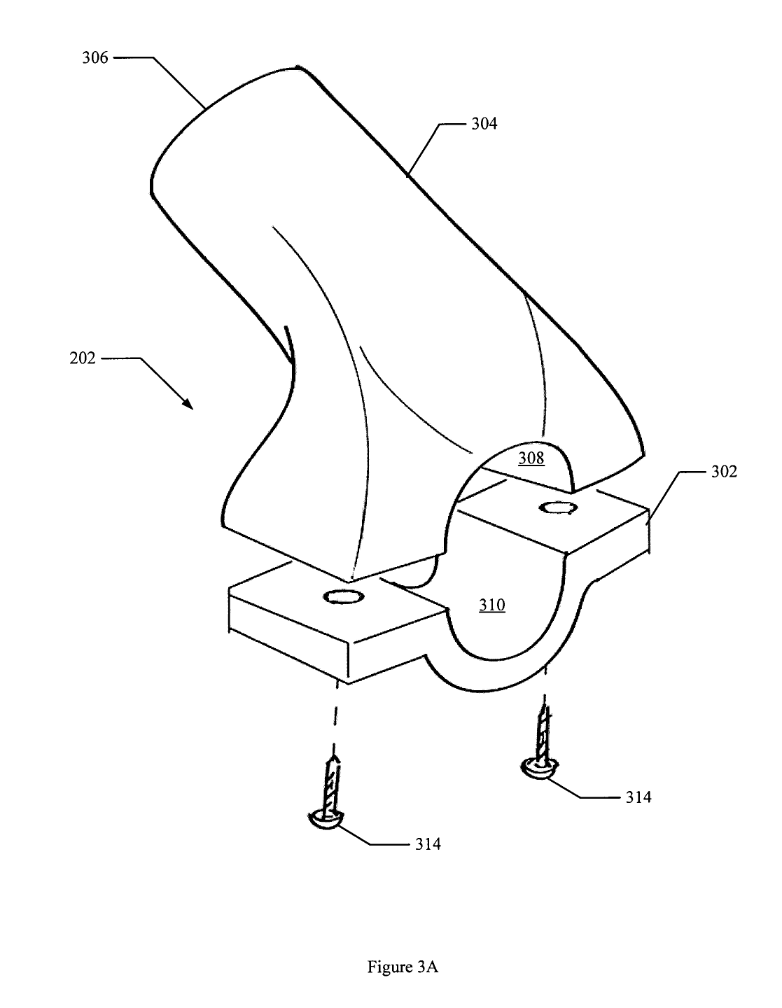

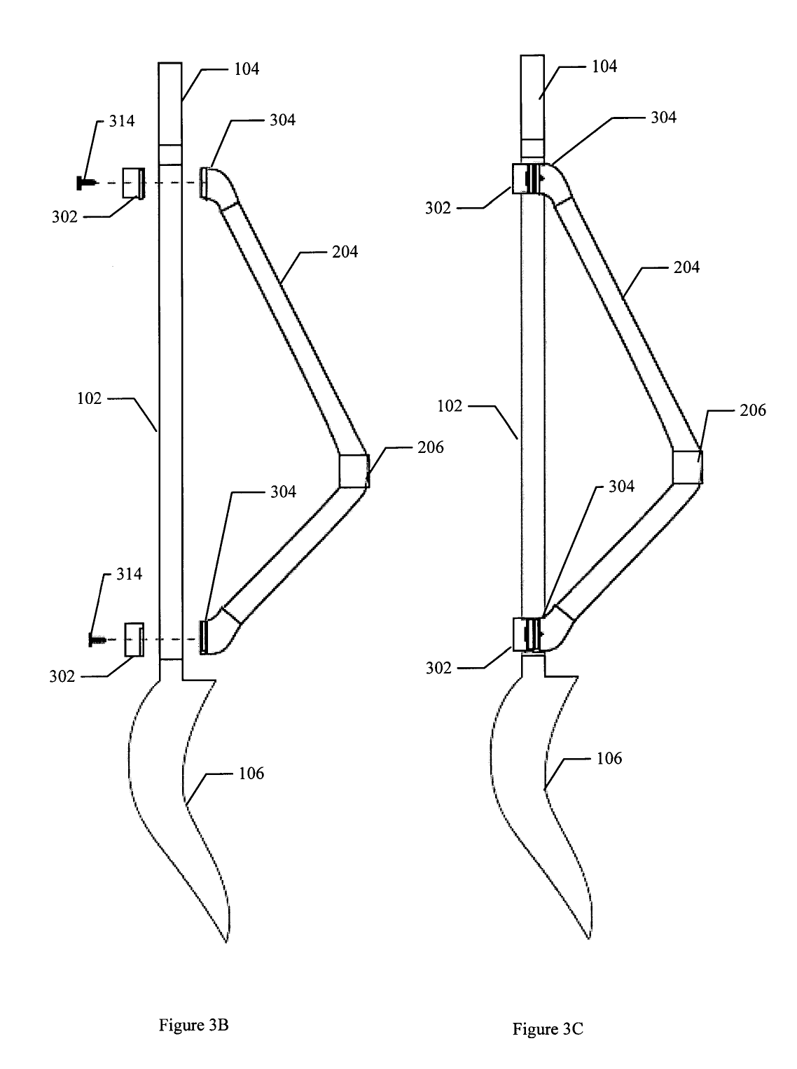

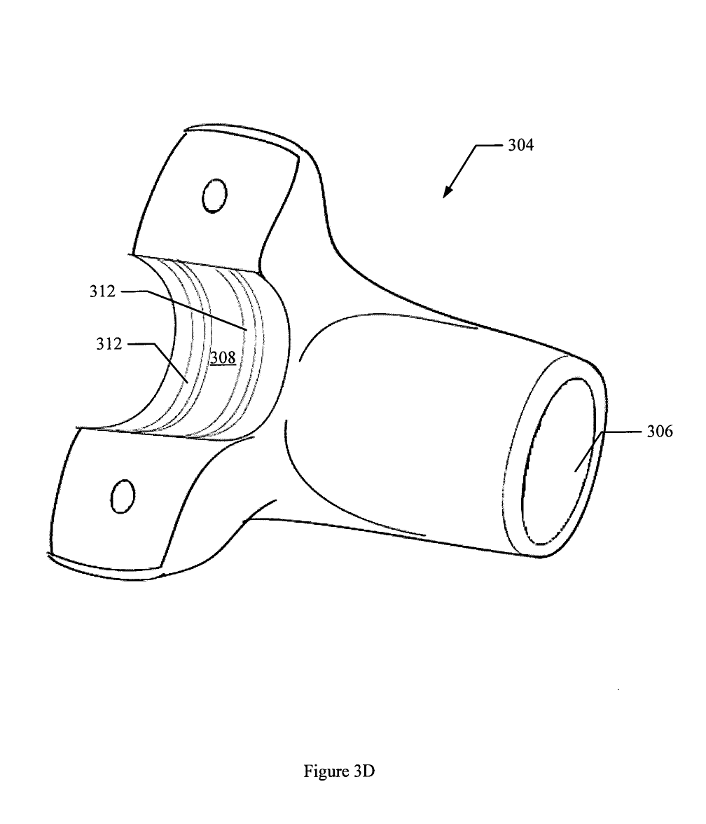

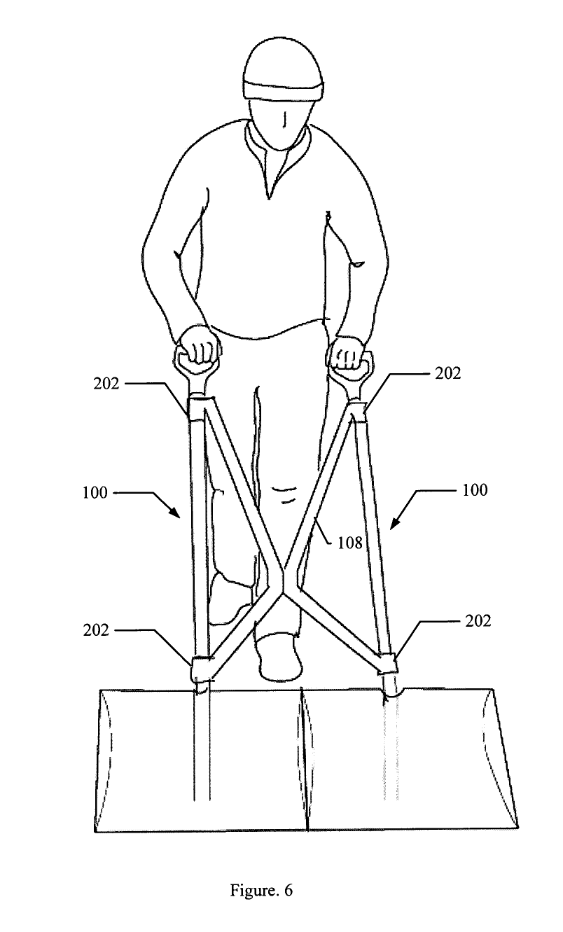

As discussed below greater detail in with respect to FIG. 3, in another embodiment, the connectors 202 may be fixed or adjustable around the neck 102 of the shovel 100. In embodiments, the connectors 202 can allow the snow shovel 100 to rotate freely when connected to the attachment 108, allowing the user to easily turn the shovel 100 to remove snow as shown in FIG. 8D. In another embodiment, the connectors 202 can fix the orientation of the attachment 108 with respect to the shovel for ease in storage or use in tandem with another shovel, as discussed with respect to FIGS. 5 and 6.

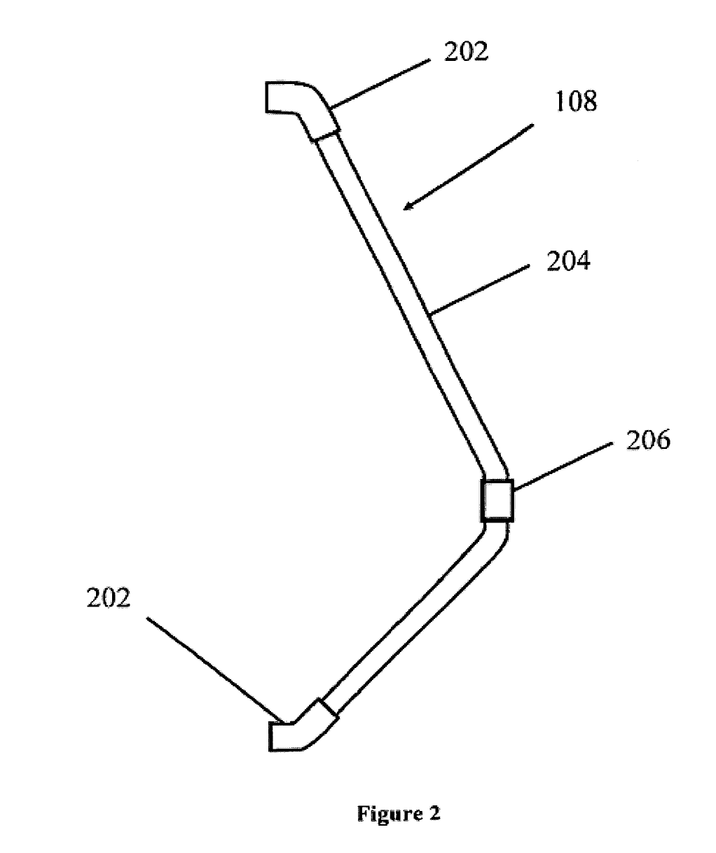

Turning now to FIGS. 2 and 7, in certain embodiments, the attachment 108 is detachable from the shovel 100 for ease of storage or transport. As shown in FIG. 2, the attachment 108 may be disconnected from the standard snow shovel 100 and stored, sold or transported separately. In another embodiment, the attachment 108 may be left connected to the standard snow shovel 100 and rotated with respect to the neck 102 of the shovel 100 to an orientation that would allow the shovel 100 and attachment 108 to easily fit into a desired space. As illustrated in FIG. 7, the attachment 108 could be rotated such that the body 108 of the attachment extends from the neck 102 of the shovel in a direction substantially parallel to the face of blade 106 of the standard snow shovel 100. This would facilitate stacking the shovel 100 and attachment 108 and allow the assembly to take up less storage space when hung, leaned against a vertical surface, or stored in the trunk of a car. The attachment 108 could be rotated to any orientation to best fit into a desired space.

Although ergonomic snow shovels with curved necks 102 may decrease the risk of injury and strain on a user, the bulky, nonlinear neck design of typical ergonomic shovels limits their potential usefulness. An ergonomic shovel frequently will not fit in the trunk of a car, or takes up excessive space, which significantly limits the shovel's portability. Likewise, the bulk of the ergonomic shovel resulting from its non-linear shape makes it more difficult to store in a garage or other storage space, especially if space is limited. Users may choose to leave shovels outside or leave them lying around a garage or other storage space instead of storing them more effectively. In contrast, the attachment 108 can be removed for storage, or simply rotated to reduce storage space requirements.

Turning again to FIG. 2, an embodiment of the attachment 108 is comprised of a non-linear body 204 having at least one point or portion that would project a distance away from the neck 102 of a shovel 100 when the attachment 108 is connected to the shovel 100. The attachment 108 includes connectors 202 at each of the ends of the body 204, and a combination element 206. In the illustrated embodiment, the combination element 206 is positioned at or near a point or portion of the body 204 distal from the neck 102, when the attachment 108 is connected to the shovel 100. In an embodiment, the attachment 108 is sized or configured to connect to standard snow shovels 100. Consequently, the attachment 108 can be sold, manufactured, and shipped separately from the snow shovel 100.

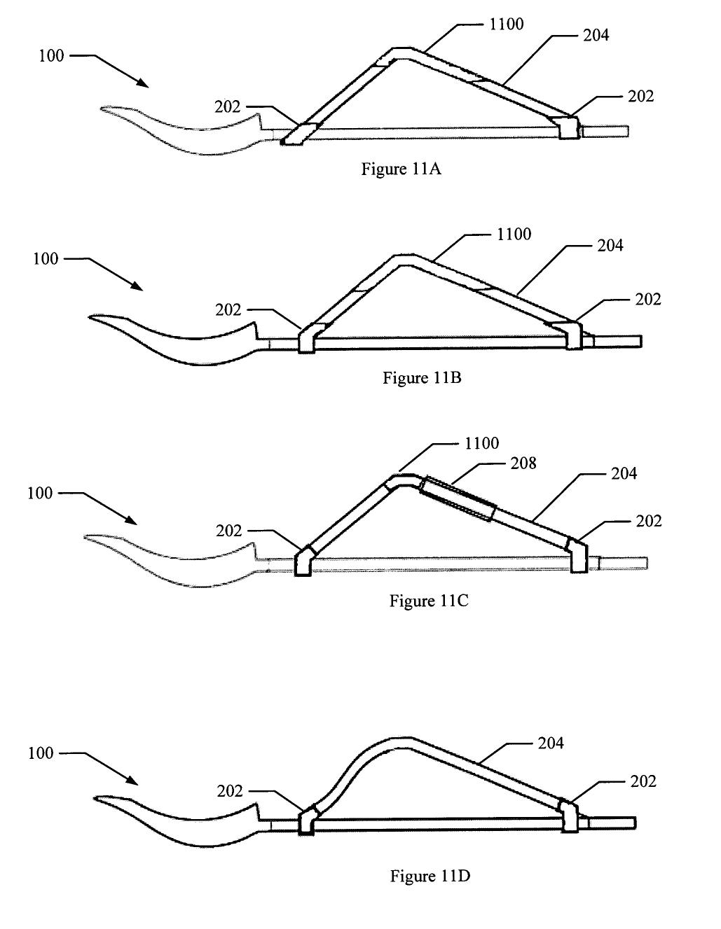

In an embodiment, the body 204 is rigid or substantially rigid, extending from the upper connector 202 for a distance before coming to at least one point or section substantially parallel to the neck 102 when the attachment 108 is connected to a shovel 100 and then extending further at an offset angle back to the shovel 100 to the lower connector 202. In an embodiment, the body 204 can be bent at an obtuse angle as shown in FIG. 2. Alternatively, the body 204 can be curved or bow-shaped, as shown in FIG. 11D. Any shape can be used that allows the user to grasp the body 204 at an appropriate distance from the shovel neck 102. An embodiment can include a body 204 of any shape with at least one portion that is a distance away from the neck 102 when connected to the shovel 100. The distance allows the user to grasp the shovel 100 at another point higher off the ground, reducing the need for the user to bend over when shoveling.

In other embodiments, the shape of the body 204 may be any shape that would allow two attachments 108 to connect together with the combination element 206, as described further below with respect to FIG. 5. As depicted, the cross-section of the body 204 of the attachment 108 can be cylindrical. In other embodiments, however, the body 204 can be elliptical, rectangular, or any other suitable shape.

In an embodiment, the body 204 extends approximately 8.5 inches perpendicularly from the neck 102 of the shovel 100, and the connectors 202 of the attachment 108 are approximately 30 inches apart. The 8.5 inch extension of the body 204 would, accounting for an approximately one inch width of the neck 102 of the shovel 100, enable a user using a plow assembly as described in greater detail in FIG. 5 to use two shovels 100, each of which would have a blade 106 of approximately 18 inches in width. Many states require that a 36-inch path be cleared on sidewalks. Use of the plow assembly can allow for sufficient clearance to comply with state laws. A 30-inch length between the connectors 202 of the attachment 108 corresponds to a length slightly shorter than the average length of the necks 102 of most standard snow shovels 100. If the attachment is used with a shovel 100 with a neck 102 that is longer 30 inches, the attachment 108 can remain in contact with the end of the handle 104 due to friction and upward forces directed towards the handle 104 of the shovel 100 while collecting snow. As shown, the body 204 has a bend approximately one third of the way along the length of the body 204. The angle between the neck 102 and the portion of the body 204 of the attachment 108 proximate to the blade 106 is approximately 60 degrees. The angle between the neck 102 and the portion of the body 204 of the attachment 108 proximate to the handle 104 is approximately 35 degrees. The body may be formed of metal such as aluminum, plastic materials, or a combination of metals, plastics, woods or any other suitable material.

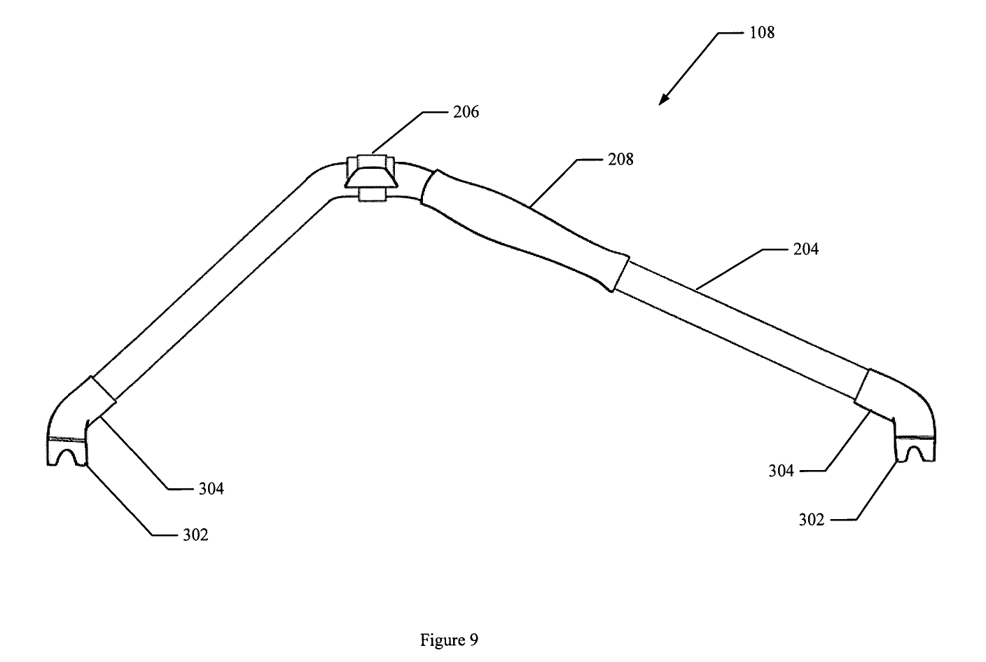

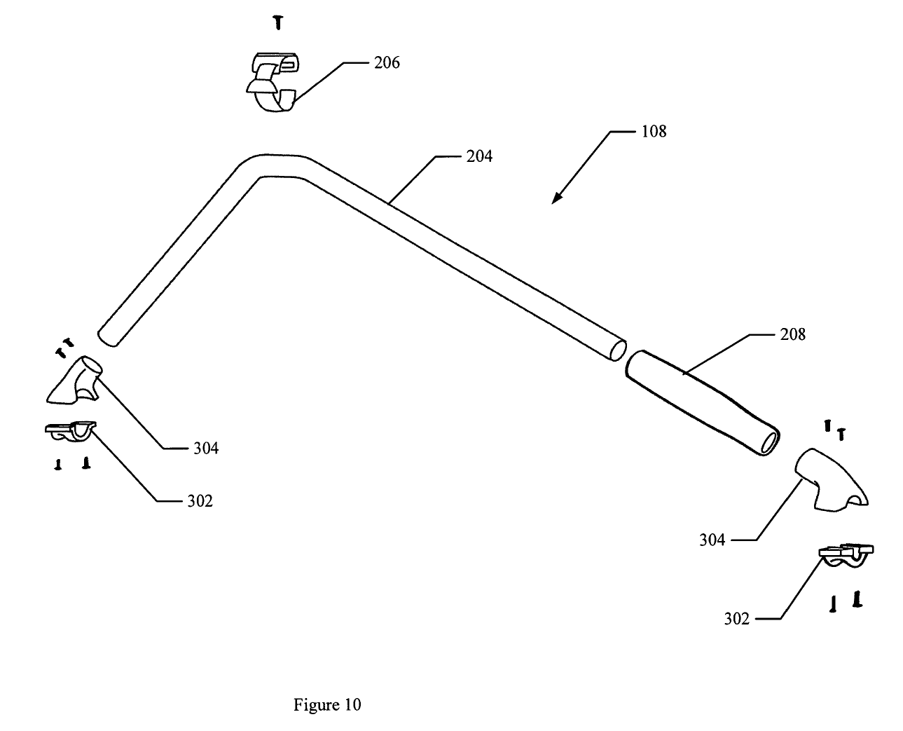

As shown in FIGS. 9 and 10, an embodiment of the attachment 108 includes a grip 208, that can be added to the body 204 of the attachment 108. The use of a grip 208 would allow a user to utilize the attachment without handling the body 204 directly. The grip 208 may be a removable sleeve that wraps around the body 204, as seen in FIG. 10, or the sleeve may be permanently fixed to the body 204. In embodiments, the grip 208 is shaped to facilitate grasping the attachment 108 and applying force to the attachment 108 and shovel 100. For example, in an embodiment, the grip 208 has an increased diameter at the portion of the grip 208 closest to the combination element 206. This configuration promotes handling the attachment 108 closer to the combination element 206, can reduce the likelihood that the user's hand will slip off the grip 208, and can reduce the pressure imparted on the user's hand when the user lifts the shovel 100 and the attachment 108 to release snow from the blade 106. In additional embodiments, the grip 208 may include a flare at each end so as to signal to a user that his or her hand is close to the edge of the grip 208. An additional embodiment of the grip may have any type of additional feature, including but not limited to a heating mechanism, a semi-solid portion malleable to conform to a hand, or a rigid portion shaped as to conform to a hand grasping the grip. In an embodiment, the grip is formed from a foam, plastic, or other material and can insulate the hand of the user from the body 204 of the attachment 108. A grip may be positioned anywhere along the length of the body 204 of the attachment 108.

FIG. 3A illustrates an embodiment of the connectors 202, used as an upper connector 202 and a lower connector 202. The connectors 202 may attach around the neck 102 of the standard snow shovel 100, as shown in FIGS. 3B and 3C. In the depicted embodiment, the connector 202 includes a bracket 304 and a C-shaped collar or clamp 302 that are joined by one or more screws 314.

As shown in FIGS. 3A-3D, the bracket 304 can include an aperture 306 shaped to secure the bracket to the body 204 of the attachment 108. In an embodiment, the aperture 306 is shaped such that an end of the body is seated within the aperture 306 and can be secured by a fastener, such as a nail or screw, or an adhesive. Any suitable means for securing the bracket 304 to the body 204 can be utilized. The bracket 304 can also include a channel or portion 308 shaped to mate with the neck 102 of a standard snow shovel 100. In embodiments, the bracket 304 contains one or more raised ribs 312 that reduce the surface of contact between the neck 102 of the shovel 100 and the bracket 304. The ribs 312 result in low friction contact between the bracket 304 and the neck 102 of the shovel 100. The collar 302 can be connected to the bracket 304 with fasteners, or using any other suitable method of attachment. As depicted, the connectors 202 use screws 314 to attach the collar 302 to the bracket 304. In other embodiments, however, the method for connection can include adhesives, movable and lockable portions, straps, or any other suitable way to close the portion around the neck 102. In an embodiment, the collar 302 includes portion 310 shaped to mate with the neck 102 of a standard snow shovel 100. The neck 102 would then rest within the combined bracket 304 and collar 302.

In embodiments, the combined bracket 304 and collar 302 could apply a variable amount of pressure to the neck 102, such as by tightening the screws 314. This variation in pressure allows the user to set or determine the amount of force needed to rotate the standard snow shovel 100 within the attachment 108. The tightness and therefore friction between the neck 102 and the connectors 202 may be decreased to allow the user to rotate the standard snow shovel 100 more easily. Alternatively, the tightness and resulting friction may be increased to allow the attachment 108 connected to the standard snow shovel 100 to be fixed in a selected position more easily and resist changes in orientation in relation to the standard snow shovel 100. As shown, the collar 302 can be removed by removing the screws 314.

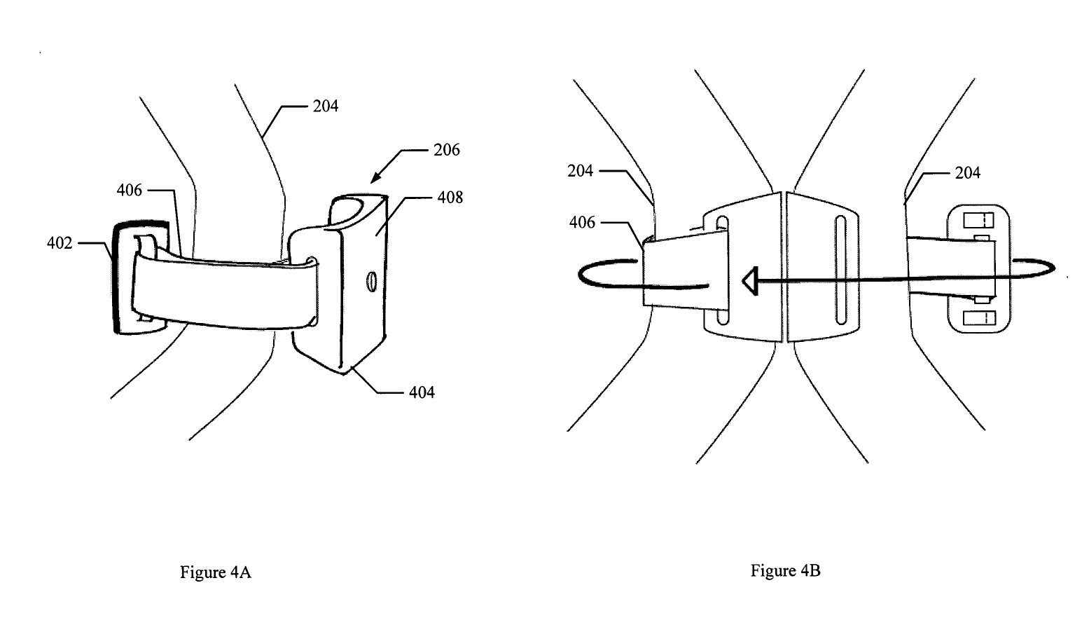

FIGS. 4A and 4B illustrate an embodiment of a combination element 206 of the attachment 108. The combination element 206 can be positioned at or near the point or section of the body 204 that extends from the neck 102 of the shovel 100. In the illustrated example, this portion of the body 204 is substantially parallel to the neck 102 when the attachment 108 is installed on a snow shovel 100 and can be used to join two attachments 108 together. As depicted, the combination element 206 is comprised of an extendable strap or body 406 with an attachment mechanism 402 at each end. A combination element 404, described in further detail below, is used to stabilize the juncture of the two attachments and secure the attachment mechanisms 402 to form a plow assembly. In other embodiments, the combination element 206 may be a C-shaped hook that can be inserted into apertures in the body 204 of the attachments 108, a temporary adhesive, a simple strap, bungee cord, or any other suitable way to connect two attachments 108 together.

In an embodiment, two attachments 108 can be joined by wrapping the extendable body 406 around the bodies 204 of each attachment 108 and securing the attachment mechanisms 402 to each other. Alternatively, a combination mechanism 404 can be used on each shovel attachment 108. In an embodiment, the combination mechanism 404 includes a surface shaped to conform to the shape of the body 204 of the attachment 108 and a flat surface 408 on the side opposite from the body 204. If this combination mechanism 404 is used with both of the attachments 108 to be joined, the flat surfaces 408 abut and help form a solid and secure connection between the two attachments 108. This can increase the sturdiness of the resulting plow assembly 500. The user can connect a first attachment mechanism 402 of the combination element 206 to a combination mechanism 404, wrap the extendable body 406 around the body 204 of the first and second attachments 108 and connect back to the combination mechanism 404 of the first attachment 108.

In another embodiment, the combination element is comprised of a hook or is C-shaped, such that one end of the combination element 206 is seated in an aperture of the attachment 108, and the other end of the combination element 206 is seated in an aperture on the opposite side of the second attachment 108. In this embodiment, the combination element effectively forms a clamp to hold the two attachments 108 together. When using hooks, a second combination element 206 connected on its first end to the second attachment 108 may rotate to latch around the body 204 of the first attachment 108.

In an embodiment, the combination element 206 can be stored or retracted so that it does not interfere with the operation of a single shovel 100 with the attachment 108. The combination element 206 can be stored by wrapping the extendable body 406 around the body 204 of the attachment 108 and connecting the attachment mechanism 402 and combination mechanism 404 to each other. In an embodiment comprised of a hook having a first and second end and an edge, to store the combination element 206, the hook is connected to the attachment 108 at the hook's first end with a device allowing the hook to rotate about the point of connection and the second end rotating to bring the edge in contact with the attachment 108.

FIGS. 5 and 6 illustrate an embodiment of a plow assembly 500. The plow assembly 500 is comprised of two standard snow shovels 100 and two attachments 108. In an embodiment of the plow assembly, each attachment 108 is oriented substantially parallel to the face of the snow shovel blade 106. The first attachment 108 is oriented in a first direction, and the second attachment 108 is oriented in substantially the opposite direction, relative to their respective snow shovels 100. At least one of the combination elements 206 of the attachments 108 connects to the other attachment 108, combining the two attachments 108 and connecting the standard snow shovels 100 and attachments 108 together. In an embodiment, the sides of the two snow shovel blades 106 abut, resulting in a wide plowing surface.

While it is possible that a user could utilize two separate shovels at the same time to form a plow without the attachments 108 and combination element 206, such a configuration would be unwieldy. The use of multiple, independent shovels simultaneously to clear a similar width of snow as a snowplow results in instability for a user. The difficulty in controlling each shovel with a single arm could easily lead to injury and would likely lead to frustration.

As depicted in FIGS. 5 and 6, two standard snow shovels 100 can be joined together by connecting two attachments 108, each of which is secured to a single standard snow shovel 100. As shown in FIG. 6, in embodiment, the plow assembly has two snow shovel handles 104 at a comfortable distance apart from each other, allowing the user to push the plow assembly 500 evenly with both hands, resulting in increased strength and decreased body contortion. For many users, the handles 104 would be near shoulder width apart, allowing more power to transfer to the plow assembly 500 and therefore move more snow more easily. The alignment of the two shovels 100 in the same direction would allow the user to move a greater quantity of snow and clear a larger surface area with ease. This use of the attachments 108 and combination element 206 result in a stable configuration of the shovels 100. The pressure from the combination element 206 ensures that the blade 106 of the first shovel 100 abuts the blade 106 of the second shovel 100. Similarly, the attachments 108 hold the necks 108 and handles 104 of the shovels 100 at a fixed relationship to each other and prevent the shovels 100 from slipping or twisting in the grasp of the user. The configuration can eliminate the need for the purchase of a larger plow, instead allowing two standard snow shovels 100 to be combined to act as a plow.

FIG. 9 and FIG. 10 illustrate additional embodiments of the attachment 108. FIG. 10 provides an exploded view of the attachment 108 for assembly, while FIG. 9 depicts an assembled attachment 108, including grip 208 and combination element 206 stored on the attachment 108, and ready for use to connect two shovel attachments 108 and form the plow assembly. As shown, in embodiments, the grip 208 is a simple sleeve that can be slid over the body 204 of the attachment 108 and slid into the desired position. The grip 208 can be held in place on the body 204 by a mechanical means such as a screw, an adhesive, or simply friction. As shown in FIG. 10, the body 204 of the attachment 108 can be formed as a unitary piece, or can be composed of multiple pieces, described in more detail with respect to FIGS. 11A-D.

FIGS. 11A-11D display additional embodiments of the attachment 108. FIG. 11A depicts an embodiment of an attachment 108, where the body 204 is formed from different materials. For example, a handhold 1100 or portion of the body 204 where the user is likely to grip the attachment 108 can be formed from a plastic, wood, or other suitable material, while the remainder of the body can be formed from a metal, including without limitation, aluminum. Use of a plastic or other material that conducts heat less readily than a metal would help keep a user's hand warm when grasping the attachment 108. FIGS. 11B & 11C show a shovel 100 equipped with embodiments of the attachment 108, with variations on dimensions of the handhold 1100 or portion of the body 204 of the attachment formed from various materials. The embodiment shown in FIG. 11C also incorporates a grip 208.

FIG. 11D depicts a shovel 100 equipped with an embodiment of an attachment 108 with a curved body 204 with bends proximal to the upper connector and the lower connector. In the illustrated embodiment, the body 204 can be formed from a single tube or pipe. The body can be a single tube or pipe formed in any shape that allows the user to easily grasp the attachment 108 to the upper connector 202 and the lower connector 202, with metal comprising the remainder of the attachment 108.

While preferred embodiments have been shown and described, it will be appreciated by those skilled in the art that changes may be made in those embodiments without departing from the principles and the spirit of the devices and methods, the scope of which is defined in the appended claims.

What is claimed is:

1. An attachment for a shovel, the attachment comprising:
a body having a first end and a second end, wherein the body is configured to provide a user with a handhold offset from a neck of the shovel when the attachment is mounted on the shovel;
a lower connector disposed at the first end of the body, wherein the lower connector is configured to attach to a neck of the shovel proximate to a blade of the shovel; and
an upper connector disposed at the second end of the body, wherein the upper connector is configured to attach to the neck of the shovel proximate to a handle of the shovel and distal from the blade,
wherein the shovel is rotatable relative to the attachment when the upper connector and the lower connector are attached to the handle of the shovel.

2. The attachment of claim 1, wherein the upper connector and the lower connector cradle the neck of the shovel, such that the shovel rotates within the upper connector and lower connector to facilitate dumping material from the blade of the shovel when operating the shovel.

3. The attachment of claim 1, the upper connector comprising:
a bracket having a channel shaped to mate to the neck of the shovel; and
a collar configured to connect the bracket to the neck of the shovel.

4. The attachment of claim 3, wherein the channel includes at least one ridge configured to reduce friction during rotation of the shovel relative to the attachment.

5. The attachment of claim 3, wherein the collar is adjustable and configured to selectably fix the position of the attachment with respect to the shovel.

6. The attachment of claim 1, further comprising a combination element mounted to the body, such that the combination element is configured to secure the attachment to an second attachment mounted to a second shovel, such that the shovel and the second shovel form a plow assembly.

7. The attachment of claim 6, wherein the blade of the shovel abuts a second blade of the second shovel in the plow assembly.

8. The attachment of claim 6, wherein the combination element includes a C-shaped hook.

9. The attachment of claim 6, wherein the combination element includes
a strap configured to encircle the body of the first attachment and the body of the second attachment;
an attachment mechanism that secures the strap around the attachment and secondary attachment; and
a combination element configured to stabilize the plow assembly.

10. The attachment of claim 8, further comprising a combination mechanism that comprises a surface configured to conform to the body and a substantially flat surface, such that the combination mechanism stabilizes the joining of the attachment and the second attachment.

11. The attachment of claim 1, wherein the body extends approximately 8.5 inches perpendicularly from the neck of the shovel when the attachment is mounted on the shovel.

12. The attachment of claim 11, wherein the upper connector is positioned approximately 30 inches from the lower connector.

13. The attachment of claim 1, wherein the handhold comprises a grip connected to the body.

14. The attachment of claim 1, wherein the body is formed from aluminum.

15. An attachment for a shovel that forms a plow assembly, comprising:
a body having a first end and a second end, wherein the body is configured to connect to a second attachment to form the plow assembly;
a lower connector disposed at the first end of the body, wherein the lower connector is configured to attach to a neck of the shovel proximate to a blade of the shovel;
an upper connector disposed at the second end of the body, wherein the upper connector is configured to attach to the neck of the shovel proximate to a handle of the shovel; and
a combination element that connects the body of the attachment to the second attachment mounted on a second shovel, thereby forming the plow assembly from the shovel and second shovel.

16. The attachment of claim 15, wherein the upper connector and the lower connector are configured to permit rotation of the body with respect to the shovel.

17. The attachment of claim 16, wherein the body is rotated substantially perpendicular to a face of the blade of the shovel for use in independent shoveling, and the body is rotated and substantially parallel to the face of the blade of the shovel to form the plow assembly.

18. The attachment of claim 15, wherein the attachment is removably mounted to the shovel.

19. The attachment of claim 15, wherein the body extends approximately 8.5 inches perpendicularly to the neck of the shovel when the attachment is mounted on the shovel and the upper connector is located approximately 30 inches from the lower connector.

20. An attachment for a shovel, the attachment comprising:
a body having a first end and a second end, wherein the body is configured to provide a user with a handhold offset from a neck of the shovel when the attachment is mounted on the shovel;
a lower connector disposed at the first end of the body, wherein the lower connector is configured to attach to a neck of the shovel proximate to a blade of the shovel;
an upper connector disposed at the second end of the body, wherein the upper connector is configured to attach to the neck of the shovel proximate to a handle of the shovel and distal from the blade, wherein the shovel is rotatable relative to the attachment when the upper connector and the lower connector are attached to the handle of the shovel; and
a combination element mounted to the body and configured to secure the attachment to an auxiliary attachment, such that the shovel to which the attachment is mounted and the secondary shovel to which the auxiliary attachment is mounted form a plow assembly.
